(19) United States
(12) Patent Application Publication
(10) Pub. No.: US 2003/0003862 A1
(43) Pub. Date: Jan. 2, 2003

(54) Electronic component and mobile communication device using the electronic component

(76) Inventors: Yoshitaka Yoshida, Niwa-gun (JP); Takakuni Nasu, Moriyama-ku (JP); Daisuke Kato, Komaki (JP); Tomoaki Sakurai, Komaki (JP); Hajime Yoshikawa, Kasugai (JP)

Correspondence Address: LARSON & TAYLOR, PLC, 1199 NORTH FAIRFAX STREET, SUITE 900, ALEXANDRIA, VA, 22314, US

(21) Appl. No.: 10/158,224

(22) Filed: May 31, 2002

(30) Foreign Application Priority Data
May 31, 2001 (JP) 2001-165880
Apr. 22, 2002 (JP) 2002-1195345

(51) Int. Cl. H04B 7/14

(52) U.S. Cl. 455/25; 455/41

(57) ABSTRACT

An electronic part or component for use in a mobile communication apparatus is mounted with improved joining strength to a printed substrate. The electronic part is formed by laminating first and second insulator substrates. An auxiliary electrode is arranged in a portion of a laminating layer face on one side of the second insulator substrate in a part of that laminating layer face which does not overlap the corresponding laminating layer face of the first insulator substrate.

### BACKGROUND OF THE INVENTION

1. Field of the Invention

The present invention relates to an electronic component such as an antenna switch module, a coupler, a diplexer, a duplexer, a filter, or the like, for use in a mobile communication apparatus, such as portable telephones or the like.

2. Related Art

In recent years, mobile communication devices such as a portable telephone and a simplified portable telephone (a so-called PHS) have been made remarkably light and compact. The need for compact electronic components for use in mobile communication apparatus has correspondingly increased. For example, one of the electronic components used in such mobile communication apparatus is an antenna switch module for switching an antenna between signal transmission and signal reception modes (see, for example, Japanese Patent Laid-Open No. 2001-127663).

To attach the antenna switch module to a print substrate, surface mounting of the module was conventionally performed using solder (a solder fillet) provided between an external terminal of the module and a pad portion of the print substrate. For example, referring to FIG. 8, in an antenna switch module 10 corresponding to that disclosed in the above-mentioned Japanese Patent Laid-Open No. 2001-127663, an external terminal 70 is formed on a side face and a bottom face of the component, and terminal 70 and an unillustrated conductor of a print substrate 90 are joined to each other by a solder fillet 130, and surface mounting is thus performed.

However, as the electronic component itself is made more compact, the area of the external terminal provided on the electronic component, i.e., the area of a portion used in the joining operation, is correspondingly reduced. Therefore, it eventually becomes impossible to obtain sufficient strength in the joint between the solder (corresponding to solder fillet 130) and the external terminal of the electronic part. More particularly, when the print substrate mounting the antenna switch module thereto is dropped or otherwise impacted, a problem can arise in that the antenna switch module may, in some cases, fall off from, or become otherwise detached from, the print substrate because of the impact.

Further, as shown in FIG. 9, when the antenna switch module comprising first (lower) and second (upper) insulator substrates is mounted to the print substrate, a clearance 150 is formed between the solder fillet 130 and the second insulator substrate since no solder fillet 130 is joined to the second insulator substrate. Therefore, when an external force is applied to the antenna switch module, such as an impact which results from dropping the device, the resultant stress is concentrated in a laminating layer interface between the first and second insulator substrates so that a crack can be formed in the laminating layer body. Therefore, as a result, there is also the possibility that a circuit within the laminating layer body can become short-circuited or disconnected.

### SUMMARY OF THE INVENTION

In order to overcome the above problems, an object of the present invention is to provide an electronic component for use in a mobile communication apparatus which affords improved strength in the joint between the component and a print substrate such as a printed circuit board, while another object is to provide a mobile communication apparatus using such an electronic component.

In accordance with one aspect of the present invention, an electronic component is provided which comprises at least first and second insulator substrates laminated one on another in a laminating direction; an external terminal provided on an edge face of the first insulator substrate and extending in the laminating direction, and an auxiliary electrode provided in at least one portion of a laminating face on a side of the second insulator substrate in a part of said laminating face which does not overlap the corresponding laminating face of the first insulator substrate. It is noted that the phrase laminating face as used above does not mean only a contact portion between the laminated first and second insulator substrates, but can rather mean the entire surface of the second (first) insulator substrate side of the first (second) insulator substrate. Accordingly, the area of the contact portion available for solder joining (e.g., soldering) is increased so that the joining strength of the electronic component is improved.

The insulator substrate of the present invention is also referred to herein as an insulating layer. Further, the electronic component of the present invention is preferably a mounting type electronic component adapted to be mounted to a print substrate or the like.

Preferably, the electronic component of the present invention includes a concave recess formed on the side face of the first insulator substrate, and the external terminal is formed in the concave recess. With this arrangement, it is not necessary to provide extra space for accommodating the auxiliary electrode on the second insulator substrate. Therefore, there is no increase in size of the second insulator substrate or consequently, of the entire electronic component, and the strength of the joint made to the print substrate can be improved. Further, it is not necessary to reduce the first insulator substrate in size so as to provide extra space for accommodating the auxiliary electrode on the second insulator substrate. As a result, it is not necessary, from the point of view of ensuring proper attachment to the print substrate, to change the existing wiring conductor pattern on the print substrate to correspond with the change in the size of the first insulator substrate. As a consequence, the time required by the design stage of manufacture can thus be reduced.

The electronic component of the invention is suitable for mounting on a print substrate by using solder. In the mounting process, a solder fillet is wetted and spreads to both the external terminal and the auxiliary electrode and is thereby joined to both the first and second insulator substrates. As a result, the joining strength of the joint to the print substrate is thus improved.

Preferably, the auxiliary electrode and the external terminal are connected to each other on the surface of a laminating layer body formed from the first and second insulator substrates. In this way, an end face of the laminating layer face of the first insulator substrate is covered with the solder fillet. Accordingly, stress is not concentrated at the laminating layer interface between the first and second insulator substrates. This avoids the generation of cracks and any resulting short-circuiting in a circuit formed within the laminating layer body.

Preferably, the first and second insulator substrates are constructed by glass ceramic formed by a ceramic component and a glass component. Accordingly, a low resistance metal such as Cu, Ag, and the like can be used as materials for the capacitor, the inductor, the external terminal and the auxiliary electrode. Therefore, the electronic component has excellent high frequency characteristics. Further, since glass ceramic normally has a low “burning” temperature of, e.g., about 1000° C. or less, the burning temperature required during the manufacturing process can be reduced in comparison with that required when using a ceramic formed by alumina.

Preferably, the auxiliary electrode is formed in only an edge end portion of the laminating layer face on the side of the second insulator substrate. Accordingly, it is possible to avoid unwanted connections to a circuit pattern (e.g., a capacitor and an inductor) formed within the laminating layer body, and also to reduce the parasitic inductance of the auxiliary electrode itself.

Preferably, at least one of (i) a capacitor electrode constituting a capacitor and (ii) an inductor electrode constituting an inductor is provided, and the capacitor electrode and said inductor electrode are formed within, or on the surfaces of, the first and second insulator substrates. As a result, the entire electronic component can be made compact, and, in particular, can be reduced in height in comparison with an electronic component in which the capacitor and the inductor are mounted as a chip part on the laminating layer body constituting the electronic component.

In one advantageous embodiment, the electronic component includes: a diplexer comprising at least a capacitor and an inductor; a high frequency switch comprising at least a semiconductor element and an inductor; and a filter comprising at least a capacitor and an inductor; the semiconductor element of the high frequency switch being mounted on the second insulator substrate; and an inductor electrode constituting the inductor of said high frequency switch, an inductor electrode constituting the inductor of said diplexer and a capacitor electrode constituting the capacitor of said diplexer, and an inductor electrode constituting the inductor of said filter and a capacitor electrode constituting the capacitor of said filter being formed within, or on the surfaces of, said first and second insulator substrates. As a result, the electronic component itself can be made compact by arranging the capacitor and the inductor as internally layered elements and a diode constituting the semiconductor element can be mounted on the laminating layer body. Further, even when the diode is so mounted and the weight of the electronic component itself is consequently increased, the strength of the joint between the electronic component and the print substrate is improved because the area of a portion joined to the solder joint relative to the entire electronic component is increased.

In accordance with another aspect of the invention, a mobile communication device is provided which includes the above described electronic component. In such a mobile communication device, since the electronic component having a joint to the print substrate of improved strength is used, the overall mechanical and electric reliability is improved, particularly with respect to its resistance to failure due to external shock such as caused by dropping of the mobile communication device or by other impact.

Further features and advantages of the present invention will be set forth in, or apparent from, the detailed description of preferred embodiments thereof which follows.

### BRIEF DESCRIPTION OF THE DRAWINGS

FIG. 1 is a sectional view of an antenna switch module (electronic component) in accordance with the present invention as mounted on a print substrate;

FIG. 2 is an enlarged sectional view of an external terminal portion when the antenna switch module (electronic component) of FIG. 1 is mounted on a print substrate;

FIG. 3 is a block diagram schematically showing the circuit structure of an antenna switch module for use in a mobile communication device;

FIG. 4 is a circuit diagram showing in more detail the construction of the antenna switch module (electronic component) of FIG. 3 for use in a mobile communication device;

FIG. 5 is an exploded perspective view of part of a laminating layer body constituting an antenna switch module (electronic component) in accordance with the present invention;

FIG. 6 is an underneath side or bottom perspective view of an antenna switch module (electronic component) in accordance with the present invention;

FIG. 7 is a top plan perspective view of the antenna switch module (electronic component) of FIG. 6;

FIG. 8 is a sectional view of a conventional antenna switch module as mounted time on a print substrate; and

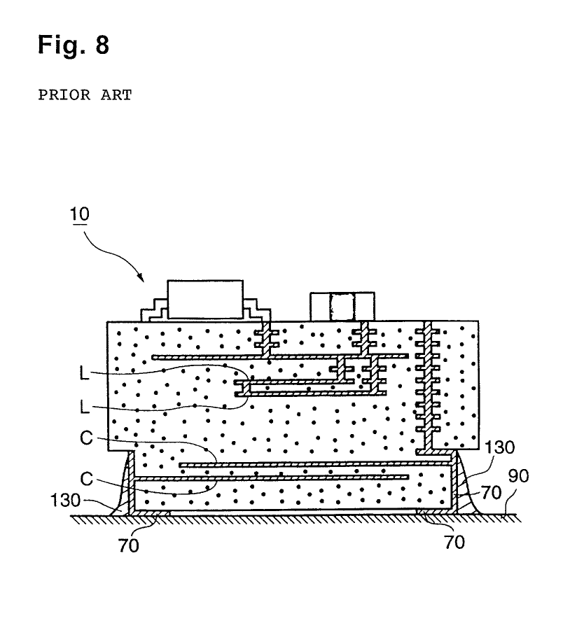

FIG. 9 is an enlarged sectional view of an external terminal portion of a conventional antenna switch module of FIG. 8 as mounted on the print substrate.

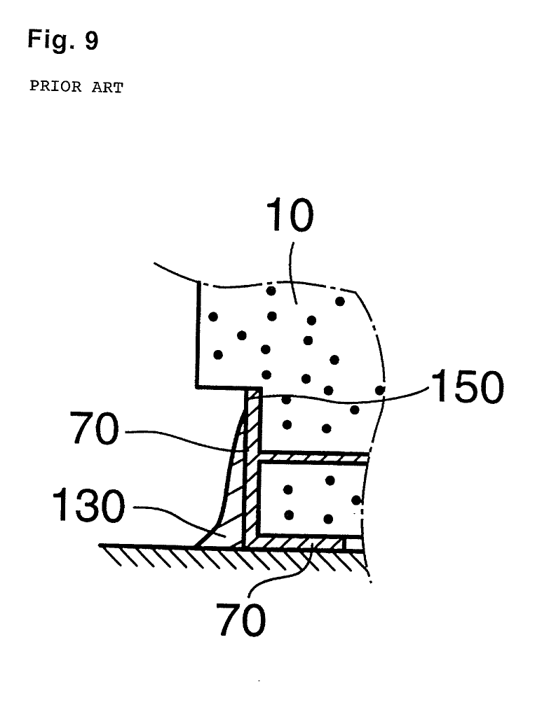

### DESCRIPTION OF THE PREFERRED EMBODIMENTS

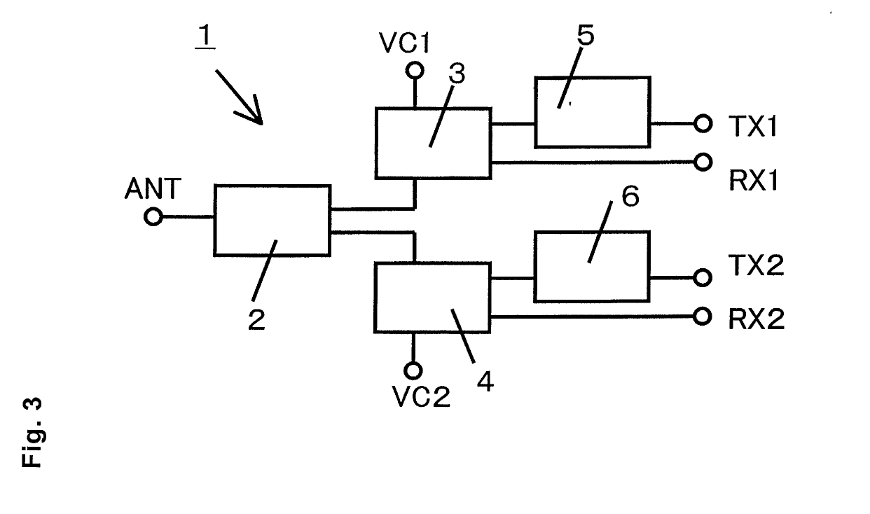

The embodiments of the present invention will next be described with reference to the drawings. An antenna switch module 1 is given as one example of an electronic component of the present invention. As shown in the block diagram of FIG. 3, the antenna switch module 1 is formed of a diplexer 2, first and second high frequency switches 3, 4 and first and second filters 5, 6. The antenna switch module 1 also includes a transmitting terminal TX1 connected to a GSM (900 MHz band) transmitting section, a transmitting terminal TX2 connected to a DCS (1.8 GHz band) transmitting section, a receiving terminal RX1 connected to a GSM receiving section, a receiving terminal RX2 connected to a DCS receiving section, an antenna terminal ANT connected to an antenna, control terminals VC1, VC2 connected to a control section, and a ground terminal GND connected to a reference electric potential of a wireless section.

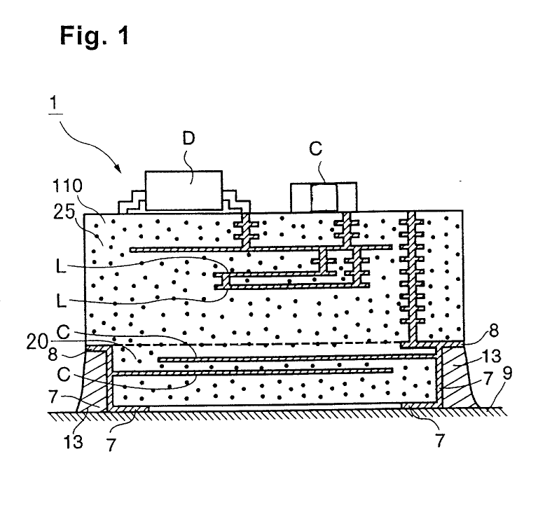

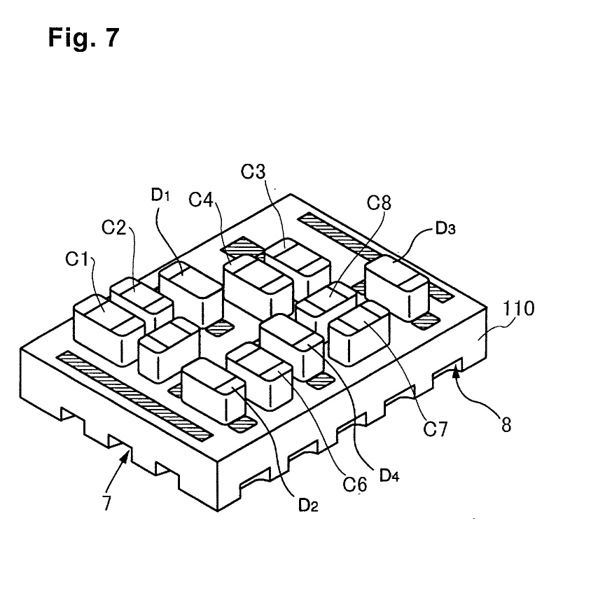

As shown in FIGS. 1 and 7, the antenna switch module 1 is formed of a laminating layer body 110 in which a plurality of insulating layers (insulator substrates) are laminated. The insulating layers (insulator substrates) constituting the laminating layer body include an insulating layer having an external terminal 7 on its side face. With respect to the elements constituting the antenna switch module, the diplexer 2 and the filters 5, 6 are respectively constructed by, or formed by, an inductor L and a capacitor C. The diplexer 2 and the filters 5, 6 are respectively formed by an electrode pattern of a predetermined shape on the insulating layer, and are internally layered in the laminating layer body.

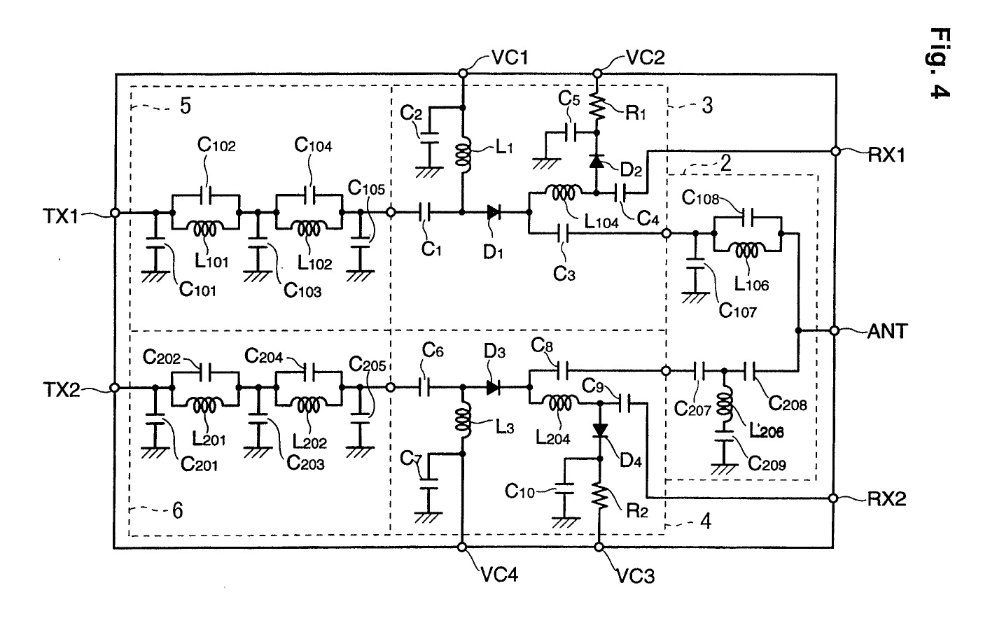

As shown in FIG. 4, the diplexer is constructed by, or formed by, combining a low pass filter and a high pass filter, and is formed by capacitors C107, C108, C207, C208, C209 and inductors L106, L206. The diplexer is connected between a high frequency switch and an antenna terminal.

As also shown in FIG. 4, the filter 5 is formed by capacitors C101, C102, C103, C104, C105 and inductors L101, L102, and constitutes the low pass filter in this embodiment.

As is also shown in FIG. 4, the filter 6 is formed by capacitors C201, C202, C203, C204, C205 and inductors L201, L202, and constitutes the low pass filter in this embodiment. The filter 6 is similar to the above filter 5 except for a difference in the pass band.

As is further shown in FIG. 4, the high frequency switch 3 has, as its function, switching between a signal path for outputting a transmitting signal (GSM) passing through the filter 5 to the antenna terminal ANT, and a signal path for inputting a receiving signal received from the antenna to the GSM receiving section. The high frequency switch 3 is formed by capacitors C1, C2, C3, C4, C5, a choke coil L1, an inductor L104, a resistor R1 and diodes D1, D2.

As is also shown in FIG. 4, the high frequency switch 4 has, as its function, switching between a signal path for outputting a transmitting signal (DCS) passing through the filter 6 to the antenna terminal ANT, and a signal path for inputting the receiving signal received from the antenna to the DCS receiving section. This high frequency switch is formed by capacitors C6, C7, C8, C9, C10, a choke coil L3, an inductor L204, a resistor R2 and diodes D3, D4.

In the antenna switch module of this embodiment, diodes D1, D2, D3, D4 of the high frequency switches are mounted onto the laminating layer body 110 as shown in FIG. 7. Capacitors C101, C102, C103, C104, C105, C107, C108, C201, C202, C203, C204, C205, C207, C208, C209 and inductors L101, L102, L104, L106, L201, L202, L204, L206, L1, L3 are respectively formed on the insulating layer in a predetermined electrode pattern, and are built in the laminating layer body 110 (5.4 mm in length, 4.0 mm in width and 0.9 mm in height). Capacitors C1, C2, C3, C4, C6, C7, C8, C9 are mounted onto the laminating layer body 110.

A metallic cap is attached so as to cover an uppermost surface of the laminating layer body 110 so as to provide a shield effect although this metallic cap is not shown in FIGS. 1 and 7.

It will be understood from the foregoing that all of the capacitors and the inductors of the diplexer 2, the filters 5, 6 and the high frequency switches 3, 4 constituting the antenna switch module do not have to be internally layered in the laminating layer body. Similarly to the diodes, components such as a capacitor of large capacitance, an inductor of large inductance, and like components unsuitable for the internal layering in the laminating layer body, may be also mounted on, rather than within, the laminating layer body as chip parts.

The insulating layer (insulator substrate) is formed of glass ceramic preferably comprising borosilicate glass and alumina. On the other hand, the electrode pattern is preferably formed by plating an Ag alloy with Ni—Au.

The antenna switch module 1 is mounted to the print substrate by using the transmitting terminals TX1, TX2, the receiving terminals RX1, RX2, the antenna terminal ANT, the control terminals VC1, VC2, the external terminal 7 of the ground terminal GND formed on the surface of the laminating layer body and an auxiliary electrode 8, and attaching these elements to wiring or conductive connections in a predetermined position on the print substrate 9 using solder.

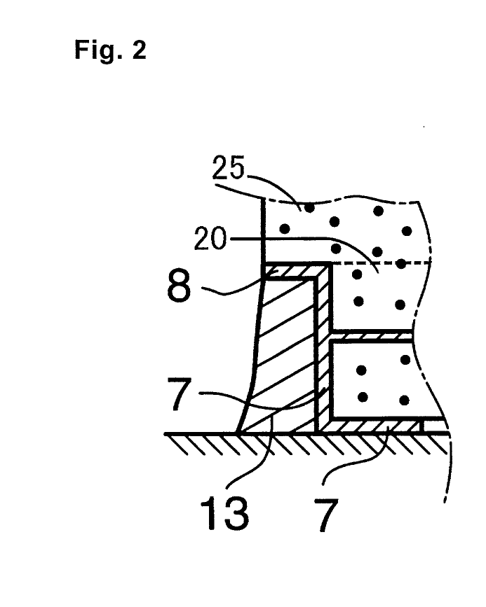

FIGS. 1 and 2 show an embodiment in which the antenna switch module is attached to the print substrate. A solder fillet 13 is joined to the external terminal 7 arranged in a first insulating layer (insulator substrate 20), to the auxiliary electrode 8 arranged in a second insulating layer (insulator substrate 25), and to an unillustrated wiring connection (pad) of the print substrate.

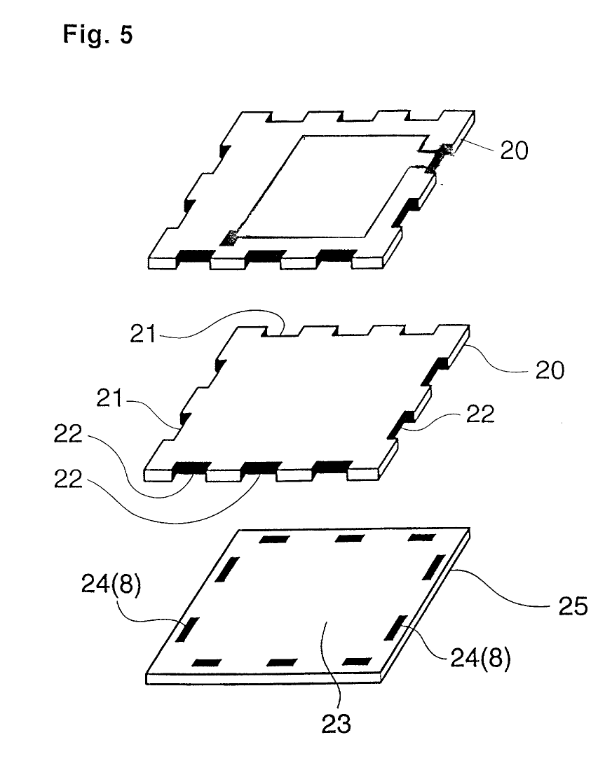

FIG. 5 is a schematic exploded perspective view which is useful in explaining the nature of the external terminal 7 and the auxiliary electrode 8 of the electronic component of the present invention. The external terminal 7 is formed in a concave groove, or recess, 21 (castellation) on a side face of the insulating layer (insulator substrate) 20, and a side face metallizing layer 22 is formed in the castellation 21. The side face metallizing layer 22 is advantageously formed by plating an Ag alloy with Ni—Au. However, the side face metallizing layer 22 is not limited to the above material, but may be formed by any suitable known material. For example, the side face metallizing layer 22 may be also formed by plating a conductor surface constructed by Ag, Cu, a Cu alloy, or the like with Ni, Ni—P, Ni-boron or a Ni—Au alloy.

As shown in FIG. 5, the auxiliary electrode 8 is formed by a surface metallizing layer 24 on a laminating layer face 23 of the second insulating layer (insulator substrate) 25, lying on a print substrate side in the antenna switch module shown in FIG. 1. Similarly to the above side face metallizing layer, the surface metallizing layer 24 can be formed by a suitable known material, using a method such as screen printing, or the like.

It is not necessary to form the auxiliary electrode 8 on the entire laminating layer face 23 of the second insulating layer (insulator substrate) 25. The auxiliary electrode 8 is preferably formed only at an edge portion of the second insulating layer (insulator substrate 25), where the second insulator substrate 25 does not overlap, but instead overhangs, the first insulator substrate 20 at the positions of the castellations 21.

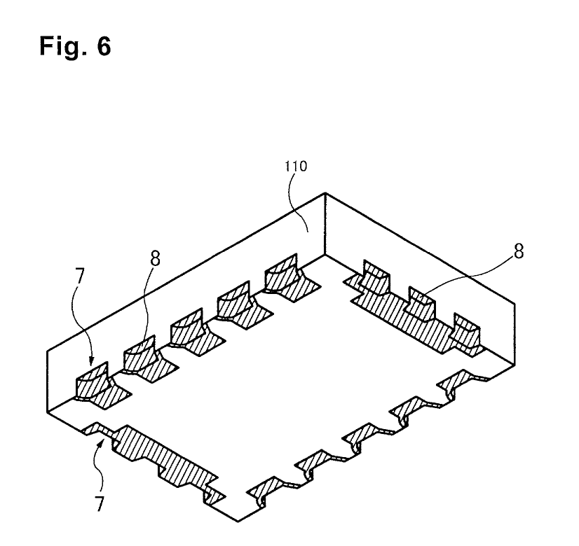

As shown in FIG. 6, external terminals 7 are formed along one side face of the insulating layer (insulator substrate) 20, and external terminals 7 of the same number are also formed along an opposed side face of the insulating layer (insulator substrate) 20. Therefore, the joint made with the print substrate is strengthened.

Each external terminal 7 and the corresponding auxiliary electrode 8 are formed on the laminating layer body surface in such a way that the terminals 7 and electrodes 8 are continuously connected to each other. Thus, the solder forms a solder fillet such that the solder is wetted to and spreads across both the external terminal and the auxiliary electrode. No clearance is formed between the second insulating layer (insulator substrate) and the solder fillet. Further, an edge portion of the laminating layer face at the sides of the first insulating layer (insulator substrate) is also covered with the solder fillet.

As shown in FIG. 6, the auxiliary electrode 8 is formed on the entire part of laminating layer face 23 at the side of the second insulator substrate 25 in the non-overlapping portion of the first and second insulator substrates.

The area of the non-overlapping portion of the first and second insulating layers (insulator substrates) at each external terminal is set to be 0.09 mm². In this embodiment, there are sixteen external terminals in total; these are the transmitting terminal TX1 connected to the GSM (900 MHz band) transmitting section, the transmitting terminal TX2 connected to the DCS (1.8 GHz band) transmitting section, the receiving terminal RX1 connected to the GSM receiving section, the receiving terminal RX2 connected to the DCS receiving section, the antenna terminal ANT connected to the antenna, the control terminals VC1, VC2 connected to the control section, and nine ground terminals GNDs connected to the reference electric potential of the wireless section. The area of the non-overlapping portion of both the insulating layers (insulator substrates) is thus set at 1.44 mm² in total.

The above surface metallizing layer is preferably formed in 60% or more of the area of the non-overlapping portion of the first and second insulating layers (insulator substrates) at each external terminal. In the case where this figure is 60% or less, the solder fillet is not sufficiently raised and no improvement in joint strength is obtained.

Further, the auxiliary electrode is preferably formed in 4% or more of the laminating layer face of the second insulating layer (insulator substrate). In the case where this figure is 4% or less, sufficient joining strength to the print substrate is not obtained.

The first and second insulating layers (insulator substrates) 20 are preferably constructed from glass ceramic (low temperature burning ceramic) materials. When these materials are used, the electronic component can be formed by simultaneous burning. Further, various kinds of ceramic materials such as alumina, aluminum nitride, mullite, and the like, a resin, or a composite material of ceramic and resin can be used as other materials for the first and second insulating layers (insulator substrates) 20. The first insulating layer (insulator substrate) and the second insulating layer (insulator substrate) need not necessarily be constructed from the same material, but may be constructed by combining the above materials.

In this embodiment, an antenna switch module has been described as an example of the electronic component, but it will be understood that the electronic component is not limited to an antenna switch module. In this regard, the present invention can be applied to any electronic component which is to be mounted on a print substrate.

Both an electronic component in accordance with the present invention, and an electronic component having no auxiliary electrode, were attached to a test jig and a dropping test (drop test) was performed so as to confirm the effect of the present invention. In the dropping test, the antenna switch module having the auxiliary electrode and the antenna switch module having no such auxiliary electrode were used as the electronic part, and both antenna switch modules were soldered to a jig (108×44×25 mm in size and 100 g in weight) for the dropping test. This jig for the dropping test was freely dropped onto an iron plate an arbitrary number of times from a height of 180 cm.

TABLE 1

| | Number of times of Dropping | | |
|---|---|---|---|
| | 6 | 12 | 18 |
| Auxiliary electrode | O | O | O |
| present | | | |
| No auxiliary | O | Δ | x |
| electrode present | | | |

In table 1, the following symbols are used:
O: No detachment of module from the jig resulting from the dropping test.
Δ: No detachment of module from the jig resulting from the dropping test, but a crack is formed in the substrate.
x: Detachment of the module from the jig resulting from the dropping test.

It will be appreciated from the foregoing that even when this jig was repeatedly dropped a relatively large number of times, the electronic component of the present invention did not fall off the jig as a result of the dropping test. However, the electronic component having no auxiliary electrode did fall off the jig as a result of the dropping test in one case (18 drops). Further, the laminating layer face portions of both electronic components were examined for cracks after the dropping test. As indicated above, a crack was seen to have been formed on the laminating face of the electronic component having no auxiliary electrode in one case (12 drops), but no such crack formation was seen in the electronic component of the present invention.

Further, a three-point bending test was performed on an antenna switch module having the auxiliary electrode, acting as the electronic component of the present invention, and on a corresponding antenna switch module having no auxiliary electrode. A sample used in the three-point bending test was made by joining the antenna switch module to a print substrate (manufactured using glass epoxy resin (FR-4) having an outer shape size of 0.8 mm in thickness, 30 mm in length and 38 mm in width). This sample was supported by left-hand and right-hand support bars (4 mmφ in diameter), and was pressed against a pressing bar (4 mmφ in diameter) arranged above at an intermediate position between the support bars, and the pressure was read by a load cell. The distance between the two support bars was set to 28 mm, and the pressing bar was raised and lowered at a speed of 5 mm/min.

Five samples (sample 1) each formed by connecting the auxiliary electrodes to all external terminals, five samples (sample 2) each formed without connecting the auxillary electrodes and the external terminals, five samples (sample 3) each formed by connecting the auxiliary electrode to only one of the external electrodes, and five samples (sample 4) each having no auxiliary electrode were used.

In making a judgment based on the measured parameters of a breaking time, i.e., the time at which a break occurred, a load curve was recorded by a recorder, and the time point at which a ripple was generated in the curve was taken as the breaking point.

TABLE 2

| Sample No. | Flexing amount (mm) | Breaking load (N) |
|---|---|---|
| 1 | 0.93 | 63.5 |
| 2 | 0.84 | 58.3 |
| 3 | 0.89 | 60.4 |
| 4 | 0.8 | 55.1 |

Each value is an average value.

Table 2 shows a breaking load with respect to a flexing amount. In accordance with the results of this Table 2, the flexing amount is 0.80 mm and the breaking load is 55.1 N in average value in the sample 4 (conventional product). In contrast to this, in the sample 1 (the product according to the present invention), the flexing amount is 0.93 mm and the breaking load is 63.5 N in average values. Accordingly, in comparison with the conventional product, the flexing amount and the breaking load are improved by 16% and 15%, respectively. In the sample 2, the flexing amount is 0.84 mm and the breaking load is 58.3 N in average values. In the sample 3, the flexing amount is 0.89 mm and the breaking load is 60.4 N in average values. It has been found from these results that the mounting type electronic component of the present invention having the auxiliary electrode is strong in withstanding the bending load as compared with the conventional mounting type electronic component having no auxiliary electrode. Further, it has been also found preferable to provide the auxiliary electrode in all of the external terminals, so as to be connected thereto.

Although the invention has been described above in relation to preferred embodiments thereof, it will be understood by those skilled in the art that variations and modifications can be effected in these preferred embodiments without departing from the scope and spirit of the invention.

What is claimed is:

1. An electronic component comprising:
at least first and second insulator substrates laminated one on another in a laminating direction;
the first insulator substrate having a first laminating face, and an edge face extending in the laminating direction;
the second insulator substrate having a second laminating face; and
the component further including
an external terminal provided on said edge face of said first insulator substrate; and
an auxiliary electrode provided in at least a portion of said second laminating face of said second insulator substrate, said portion of said second laminating face being in non-overlapping relationship with the first laminating face of the first insulator substrate.

2. An electronic component according to claim 1, wherein a concave recess is formed in said edge face of said first insulator substrate, and said external terminal is formed in the concave recess.

3. An electronic part according to claim 1, wherein
said auxiliary electrode and said external terminal are connected to each other on a surface of a laminating layer body formed from said first and second insulator substrates.

4. An electronic component according to claim 1, wherein
said auxiliary electrode is formed in only an edge portion of a laminating layer face on one side of said second insulator substrate.

5. An electronic component according to claim 1, further comprising:
an electrode comprising at least one of (i) a capacitor electrode constituting a capacitor and (ii) an inductor electrode constituting an inductor, and
said electrode being formed within, or on the surfaces of, said first and second insulator substrates.

6. An electronic component according to claim 1, wherein
the electronic component includes:
a diplexer comprising at least a capacitor and an inductor;
a high frequency switch comprising at least a semiconductor element and an inductor; and
a filter comprising at least a capacitor and an inductor;
said semiconductor element of said high frequency switch being mounted on said second insulator substrate; and
an inductor electrode constituting the inductor of said high frequency switch, an inductor electrode constituting the inductor of said diplexer and a capacitor electrode constituting the capacitor of said diplexer, and an inductor electrode constituting the inductor of said filter and a capacitor electrode constituting the capacitor of said filter being formed within, or on the surfaces of, said first and second insulator substrates.

7. An electronic component according to claim 1, wherein
said first and second insulator substrates are formed of glass ceramic.

8. In a mobile communication device the improvement wherein the mobile communication device includes an electronic component comprising:
at least first and second insulator substrates laminated one on another in a laminating direction;
the first insulator substrate having a first laminating face, and an edge face extending in the laminating direction;
the second insulator substrate having a second laminating face; and
the component further including
an external terminal provided on said edge face of said first insulator substrate; and
an auxiliary electrode provided in at least a portion of said second laminating face of said second insulator substrate, said portion of said second laminating face being in non-overlapping relationship with the first laminating face of the first insulator substrate.
